(19) United States
(12) Patent Application Publication
(10) Pub. No.: US 2005/0118302 A1
(43) Pub. Date: Jun. 2, 2005

(54) Method to prepare low calorie meal sets

(76) Inventor: Jacek Dlugolecki, Gdansk (PL)

Correspondence Address: Miroslaw Paczuski, 2621 Hartman drive, Center Valley, PA, 18034, US

(21) Appl. No.: 10/504,390

(22) PCT Filed: Aug. 8, 2003
(86) PCT No.: PCT/PL03/00078

(30) Foreign Application Priority Data
Aug. 13, 2002 (PL) P355471

(51) Int. Cl. A23L 1/30

(52) U.S. Cl. 426/72

(57) ABSTRACT

This is a method of preparing low-calorie meal sets for people who are loosing weight, which relies on the creation of daily sets of low-calorie food in containers, which are made up of several types of food placed in small containers, trays or hermetically sealed boxes each having a specific calorie-level for each set. Through a system of progressive calorie-levels of the sets of food, which are formulated in so-called calorie groups, a series of daily sets is produced with calorie-levels at 700 cal, 800 cal, 900 cal and so on up to 2000 cal and 2100 cal. This allows, during the process of weight loss, for the person to move from the consumption of sets with 800 cal per day to sets with 1000 cal per day and the other way around depending on the particular energy needs at the time (for instance during seasonal sports) of the person loosing weight. Buy purchasing a set with a specified calorie-level, the person loosing weight may also receive an additional psychological motivation, encouraging them to stick to their obligations—eating only that amount of food which is in the set.

The subject of the patent is a method by which one can prepare sets of meals with low-calorie-levels, which would be helpful in conducting a low-calorie diet as advised by doctors and dietary specialists.

The ideas about food-product energy-values used in this description such as the calorie-level (of food) and energy are synonymous, while the idea of the measurement of energy or the ‘calorie’ as an unofficial unit of energy is also referred to with the abbreviation ‘cal’. The description avoids the term for the measurement of heat in Joules J (where 1 calorie or 1 cal. comes to 4.1855 J).

In wealthy countries a certain number of people consume excessive amounts of food daily, which leads to being overweight and the development of a series of diseases. Despite the fact that they know the principles of rational and low-calorie eating, the inhabitants of these countries do not have enough will power and desire to limit their greed nor do they have the knowledge about the transformation of energy introduced into the organism and converted into motion or fat and muscle tissue or the calorie-levels of individual food-products. They also do not know how to create a balance sheet of energy taken into the organism in the form of food, and energy expended through work or play.

This means that a certain percentage of inhabitants of the wealthier countries consume unnecessarily large portions of food, made up of high-calorie and less healthy materials. The lack of control over the amount of food consumed is also caused by the pressure to increase one's income, overworking, looking for new work and hobbies as well as the chaos of the day's organization. A working person usually does not have the time or often the will to create a rational diet, which would be healthy and low-calorie. These factors cause a significant percentage of the population in these countries to be excessively overweight, despite the fact that there is an overall trend towards being rationally slim. A large portion of the unsuccessful attempts by individuals to loose weight is the result of organizing, preparing and eating meals and a lack of systematic and long-term treatment of overweight problems.

The food industry and the mass media do much to inform society of the proper principles of nutrition. They also inform people of special diets and pharmaceutical products that help in the process of weight loss. Furthermore, many packaged products such as fats, yoghurts, previously seasoned meats, potato products, vegetable salads and soups contain information about the energy level of the product on the package, bottle or bag. However, such informal information concerning individual packages does not make it possible for the person interested in loosing weight to eat the products in such a way as to ensure weight-loss. In order to achieve this effect, the person must calculate the amount of calories that they are not allowed to exceed during the day while consuming a series of containers of food.

Dietetics has long accepted certain standards when determining the norm for total daily-consumed energy necessary to loose weight. These amounts vary per individual and depend on the body weight, life style (for instance desk work, light activity or hard physical labor), leisure activities, and the individual's metabolism.

Based on the energy balance sheet, the conclusion has been drawn that daily consumption of low levels of calories such as a total daily intake of 1000, 1300 or 1500 calories leads to a daily decrease in weight at an appropriate rate. However, only a small number of people who wish to loose weight know how to calculate the amount of calories they burn during a given day, and even fewer people are conscientious enough to calculate the number of calories burned per day of the meals consumed and limit their daily consumption to a level of, say, 1000 or 1300 calories.

Surprisingly, it turns out that there is a way to create a method of organizing meals for people who wish to conduct a low-calorie diet that will help them in the effort to build a rational menu for people who are interested in obtaining the effect of weight-loss. This method may also be helpful in treating illnesses that are caused by being excessively overweight.

The method according to the invention is realized through pre-prepared food in the form of low-calorie dishes such as meat products, vegetables, soups, deserts and fruits that are placed in several containers which are then arranged in sets for daily consumption by the purchaser. The individual meals are defrosted, heated and consumed at meal times.

The particular feature of this type of meal set accompanied by a list and summary of the calorie content of the individual products is that the arrangement of weight is such that the energy-value of the entire set comes to a predetermined amount for a given set such as 1000, 1300 or 1600 calories. It is also important to preserve the taste values of the individual products in the entire set. Such a set may be sold in retail or gastronomic chains, which cater to clients who are interested in undergoing the process of weight-loss.

While it is true that there are known daily and short-term meal sets for military personnel, astronauts, mountain climbers and other specialists that also often include the calorie-level, it is still the case that the production of such sets according to the invention in individual calorie groups, aimed at people interested in loosing weight in as such, in creating certain habits and a certain type of psychological pressure that will encourage them to limit the level of food consumed determines a very significant element in the novelty of the solution. These sets with calorie-levels limited from 700 to 2100 calories would be made of low-calorie food-products, with limited fat and carbohydrates and would, as such, have different values than those for people conducting specific types of work and tasks as listed above,

Simultaneously, through the solution described in the invention, a complete dietary system is created for the consumer, which is the ability to choose sets of lower or higher calorie values. For example, a person desiring to undergo the process of weight-loss starts out by purchasing sets with 1600 calories and after a certain time, when the person decides that they can handle a lower limit, moves on to the sets with lower daily calorie-levels such as 1300 calories.

Also, after intensive weight loss, a person may go move back to less rigorous sets, in order to keep the achieved weight level, choosing, for instance the 1900 calorie sets, which will guarantee preservation of the weight obtained in the first level of weight-loss with the appropriate level of physical activity. As such, the solution by the invention includes a certain graduation of the consumption requirements and a flexibility in conducting the entire process of weight-loss, which is realized by choosing the appropriate set with a specific calorie-level, complying with the daily expenditure of energy for the individual loosing weight, or by changing the calorie-level during the weight-loss process.

It is also important that by offering and then selling the set in retail chains to people loosing weight, that there is a significant psychological effect on the consequences and the influence of the activity of purchasing and possessing the set on people's thoughts, which consists of concentrating the proposition of limiting one's daily food consumption exclusively to the amounts determined in the set. This is a very strong stimulus for the psychology of people loosing weight, which may prevail over their appetite and limit the meals consumed to the food in the set. In this case, a strong psychological barrier to consuming food beyond that which is in the low-calorie set is put in place. This increases the desire to voluntarily impose limitations on ones appetite.

The weight-loss system is realized by meal sets of varying calorie-levels which allow the weight-loss process to be completely controlled depending on the various activities or energy loads. As an example, if there is an increase in athletic activity during the weekend or vacation, the daily consumption can be increased by selecting sets with higher calorie-levels.

The sets will be labeled by the producer with the amount of calories contained and they will also contain a description of the contents of the individual containers. They may also be marked with numbers indicating the successive sets, according to a list made by the producer. In each of the so-called ‘calorie groups’ there should be a number of sets with different contents or meals that should be prepared to ensure the consumer a variety of food for, for instance, two weeks. It seems that in the daily low-calorie sets in each of the so-called calorie groups that the sets should have at least 7 different meals so that each of the sets will contain at least 50% different products, that is products that are not found in other sets.

The sets will contain various, specially projected meals, which will ensure that the person undergoing weight-loss will experience a decrease in appetite due to their low energy contents and the large quantities. Many different sets in various ‘calorie groups’ (for instance in the 1000, 1300, 1500 and 1800 calorie groups) will allow one to avoid a monotonous diet. The fact that the sets will be tasty will play an important factor in using the diet with the sets according to the invention, which is why it is very important that the meals are carefully prepared by specially trained dietitians.

Individual meal sets according to the invention will be formed in regular ‘calorie groups’, which will allow the person undergoing weight-loss to move from one of the sets with a lower calorie-level to a higher calorie-level set, for instance from a 1000 calorie set to a set from the 1100 calorie-group, and the other way around from a set with 1600 calories to a 1200 calorie set.

We forecast that the production of meal sets will grow by 100 calories per set from 700 to 2100 calories in a mathematical progression 700, 800, 900 . . . up to 1900 and 2100 calories. For a given calorie-level, the actual energy level in the set in the given ‘calorie group’ will vary by ±50 calories, meaning, for example, that the products in a 900 calorie set will actually have a calorie content ranging anywhere from 850 to 950 calories.

Still, it is possible for the producer of low-calorie sets to limit the number of calorie groups for practical reasons, so that the sets are produced in ‘calorie groups’ giving such daily calorie-levels as: approximately 700 calories, approximately 1000 calories, approximately 1300 calories, approximately 1600 calories, approximately 1900 calories, and approximately 2100 calories.

Specific daily meal sets in containers of specified total calorie-levels will be packed into individual containers, bags or packages and placed into retail sale by the so-called refrigerating industry through the following links: producer, refrigerated warehouse, refrigerated transport, and the freezer section of the supermarket or gastronomic establishment.

A necessary supplement to the sets should be separate containers of vitamins and microelements, which are necessary to the low-calorie diet as well as other pharmacological substances that are beneficial to the health and the process of digesting the meals by the human organism.

The presented method of production of the meal sets according to the invention allows one to create a complete system for weight-loss as well as the freedom of the person undergoing weight-loss to select a goal weight and a tempo to achieve the goal in the limits of a weight loss program and finally to plan ways to keep their weight at a balanced level.

The psychological effect resulting from the use of the food sets according to the invention, which relies on not going over the daily limit of food in the sets with specified calorie-levels purchased in the supermarket may decide the positive effects of the entire weight-loss procedure.

Examples of the Invention in Use:

### EXAMPLE 1

Person A wishes to loose weight starting out slowly at first in order to get used to the limited consumption of food and has decided to purchase food sets from the 1500 calorie group for the first month, the 1200 calorie group in the second month and finally in the third month to purchase meal sets from the 1000 calorie group. After successfully loosing weight, the person plans to progressively increase the calorie-level from the 1200 calorie-level, 1500 calories and then to 1800 calories until they find that the body has reached a stable weight level. After this period, person A will consume the sets, which will guarantee that they will keep the obtained weight, for instance, from the 1800 calorie group.

### EXAMPLE 2

Person B wants to loose weight and has a changing life style, because for three days of the week they have intense physical activity and then rest for the other 4. This person plans to eat meal sets with higher calorie-levels, for instance from the 1800 calorie group, for three days of the week when they work hard, and then for the 4 days of rest they will eat 1200 calorie sets. After achieving weight-loss, in order to keep the new weight level, person B continues to eat 2100-calorie sets during the days of hard work, and 1500 calorie sets during the days of rest. This allows person B to keep the weight they planned and achieved. After some time, when person B has become used to purchasing low-calorie meals, they will stop purchasing the meal sets prepared according to the invention.

### EXAMPLE 3

Person C wishes to reduce their weight and decides to use the meal set method according to the invention achieve weight-loss and to simultaneously increase their physical activities through riding their bicycle 20 km per day to work. As such, instead of drastically reducing the calorie-level to 1000 calories per day (as they would if they continued to drive to work) they need only reduce the calorie intake to 1800 calories per day, which means less resistance and willpower. After the planned weight level has been achieved and the person starts continues to ride their bicycle to work they can move to a higher 2100-calorie meal set. After this person has become used to consuming low-calorie foods, they will stop purchasing the meal sets prepared according tot eh invention and they will plan their own meals according to the weight-loss procedure.

1. A method of preparing low-calorie meal sets for consumption by people going to loose weight characterized in that individual meals are made almost entirely of low-calorie ingredients, packed in individual containers and grouped into a daily set for daily consumption wherein the daily set contains a list of food contained, and amount of calories in the daily set equals from 700 to 2100 cal and is arranged calorie groups in linear order every 100 calories.

2. The method according to claim 1 wherein the daily set is arranged in at least 7 different sets of food for each calorie group differing in at least 50% food of low-calorie ingredients.

3. The method according to according to claim 1 wherein only few of the calorie groups are produced.

4. The method according to claim 1 wherein supplementary substances are added to the daily set to provide vitamins microelements and pharmaceutical substances which are advantageous to health and digestion of a human organism.

5. A method of preparing the composition of low-calorie meals/foods for consumption by patients who wish to lose weight, sold in retail shops and catering outlets, in which said particular meals/foods packed into separate containers are grouped into compositions for consumption by one patient over the period of 24 hours; and that each such 24-hour composition of meals/foods, placed into a collective container, designed for consumption by a consumer within 24 hours, equipped with a list of foods specifying energy value for the whole composition, is arranged in such a way that any given 24-hour composition includes a definite total energy amount contained within the range between 700 and 2,100 calories, which allows one patient to carry out one patient's nutritional process with the weight-loss effect, and that the particular compositions containing various total energy amounts, referred to as the so-called Calorific Value Groups, are arranged along a mathematical numeric sequence for such Calorific Value Groups, every 100 calories, i.e.: 700 cal, 800 cal, 900 cal, 1,000 cal, 1,100 cal, 1,200 cal, 1,300 cal, 1,400 cal, 1,500 cal, 1,600 cal, 1,700 cal, 1,800 cal, 1,900 cal, 2,000 cal, 2,100 cal, and that the calorific content of each nutritional composition coming from each Calorific Value Group varies within the limits from plus 50 cal to minus 50 cal in relation towards the basic calorific value which defines a given Group, and that the prepared foodstuff to be found within the nutritional composition to be consumed within 24 hours is placed in the form of ready-made foods in a series of containers for consumption by a consumer after their defrosting and/or after their pre-heating, whereas the very course of weight-losing is based upon the principle of flexible and free choice made by a patient wishing to lose weight, at a given slimming therapy day and at all subsequent slimming therapy days, of an appropriate nutritional composition with energy content corresponding to the so-called Calorific Value Group, as is appropriate to a slower or faster slimming process designed by a consumer, depending upon the consumer's resistance degree towards his/her feeling of hunger.

6. The method of claim 1 in which the composition of low-calorie meals/foods comprises at least 7 different meal compositions with such a rule that each of these 24-hour compositions shall have in its collective container at least 50%, by volume, of different of meals, i.e. such that shall not repeat in other low-calorie compositions within the same Calorific Value Group.

7. The method of claim 2, in which certain energy-containing compositions, marked with the main calorific value number for a given composition, arranged in accordance with their Calorific Value Groups enumerated within a mathematical numeric sequence according to claim 1, shall not be manufactured.

8. The method of claim 2, in which such compositions shall contain additive substances as vitamins, microelements, and pharmacological substances that are useful for human health and for the process of food assimilation by human body.
